(19) United States
(12) Patent Application Publication
(10) Pub. No.: US 2017/0027137 A1
(43) Pub. Date: Feb. 2, 2017

(54) MODULE FOR STORING AND TRANSPORTING LIVE SEA PRODUCTS, IN PARTICULAR LOBSTERS, AND DEVICE INCLUDING AT LEAST ONE SUCH MODULE

(71) Applicant: EMYG ENVIRONNEMENT ET AQUACULTURE, SAS, Carnoux en Provence (FR)

(72) Inventors: Giancarlo FAGIANO, Carnoux en Provence (FR); Armand LEJEUNE, Saint Jean De Liversay (FR)

(73) Assignee: EMYG ENVIRONNEMENT ET AQUACULTURE, SAS, Carnoux en Provence (FR)

(21) Appl. No.: 15/302,701

(22) PCT Filed: Apr. 9, 2015
(86) PCT No.: PCT/FR2015/050925

§ 371 Date: Oct. 7, 2016

(30) Foreign Application Priority Data
Apr. 9, 2014 (FR) 1453154

(51) Int. Cl. A01K 63/02; A01K 63/04

(52) U.S. Cl. CPC A01K 63/02; A01K 63/04

(57) ABSTRACT

A module for storing and transporting live products, in particular sea products, characterised in that it includes a box-shaped unit which is made from a light material, which has a length L and a width I defining a front surface FF and a rear surface RF, as well as a thickness E, and which is provided with at least one recess, the size of which is equal to the overall length of a crustacean to be inserted, the recess opening onto both the front surface FF and the rear surface RF. The invention also relates to the complete device, including a plurality of juxtaposed modules, and a system for treating water with an adapted composition.

The present invention concerns a module for storing and transporting live sea products. The invention also covers the complete device for storing and transporting live crustaceans incorporating at least one module.

In the present invention, there is meant by living sea products:
crustaceans, notably lobsters, shrimps or crayfish,
mollusks such as oysters, abalone,
chinoderms such as sea urchins, or
fish such as elvers.

These products are found and fished in specific locations on the planet. In the case of the lobster, these are notably fished using lobster pots in the cold waters of Canada with areas of consumption worldwide but particularly in Europe. Elvers are fished in Europe and North Africa during their migration and the areas of consumption are also certain countries in Asia.

The great majority of these products are at present either cooked or frozen onboard the fishing boats or frozen directly in port as soon as they are landed.

However, these sea products are considered luxury products in countries far from these places of production and it is then necessary to sell them alive because the flesh is better tasting than after freezing/thawing.

Clearly there are then numerous problems for storing these live sea products from the fishing site to the retailer selling said sea products to the end user, often several thousand kilometers away.

If fishing is no longer effected in a natural environment but rather fish farming, this must be developed in places propitious to the biotope of said products and thus in the regions of natural production.

The transport problem therefore remains in its entirety, whatever the source producing these lobsters.

In fact, it must be possible to store these live crustaceans and the known solution is that of placing them in a fish tank.

The problem is nevertheless transporting on the one hand the fish tank and on the other hand the water contained in the fish tank.

If transportation is by boat, the problem is less crucial from the weight point of view but the duration is relatively long.

However, transportation is more and more often by air. Particular attention must then be paid to weight. The weight of the marketable material, that is to say the weight of the sea products, is not a problem but that on the one hand of the container and on the other hand of the water represent a severe penalty.

In this solution using a fish tank, there exist containers in which the sea products are disposed with means for oxygenating and treating the fluid in which said products are disposed. These containers comprise tanks in order to distribute the mass of the products with means for treating the water.

In the case of lobsters, for example, although each claw of the lobster is held closed by any appropriate means such as an elastic band, for example, it is not possible to bulk package too many lobsters, whence the multiplicity of tanks to provide a better distribution. The same applies to elvers and sea urchins the promiscuity of which breaks the spines.

It is also known that consumers are more and more attentive to the quality of the products, to the conditions under which they are transported and to the traceability of the products. To this end, it is necessary to be able to identify each product or each batch of products in a supplied batch or at least to be able to identify said batches.

The problems that have just been explained concern long-haul transportation but it is clear that when the container has arrived at the airport it has not reached its destination and it remains for it to get to the distribution center, generally then the wholesaler, and thereafter the retailer. This represents numerous manipulations.

This process is therefore relatively complicated at the present time because the products are in a fish tank in bulk so that identification is not easy and the distribution of the live products to the final retailer remains complex.

Thereafter, the living sea products, crustaceans, oysters, are either sold on ice for a quick sale or remain in a fish tank on the premises of the retailer for later sale or sale over a period that must not exceed a few hours.

It is also known that transfers can stress mammals and animals in general but these transfers also disturb sea products, through a change of temperature, salinity or environment, to cite only those parameters.

The object of the present invention is to alleviate the problems that have just been explained, enabling application to the transportation of fishing products obtained from fishing in a natural environment and from fish farming.

The device in accordance with the present invention makes it possible to solve the problem of the weight of water to be transported by reducing its volume and therefore its weight to the minimum necessary for the benefit of the sea products.

In simple terms, the present description relates more particularly to transporting crustaceans and notably lobsters but complementary arrangements show the application of the present invention to other products without modification.

The device in accordance with the present invention makes extremely simple and rapid distribution possible while preserving the traceability of each of the sea products or at least of the batches of those products.

The device in accordance with the present invention is of low cost and limits the stress on the sea products, notably by limiting transfers.

The device in accordance with one particular, non-limiting embodiment is described next with reference to the appended drawings, the figures of those drawings representing:

FIG. 1: a perspective view of the device with walls of modules in a transportation container, with lobsters,

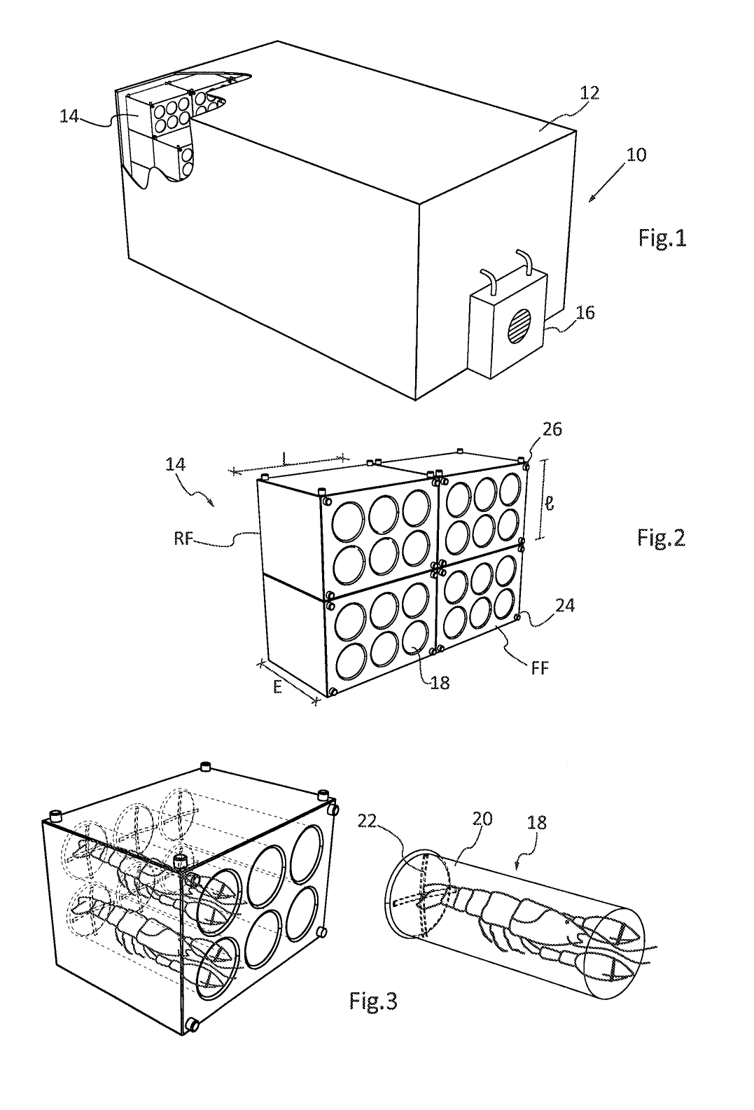

FIG. 2: a perspective view of the empty device with a module comprising a limited number of housings, to illustrate the detailed architecture,

FIG. 3: a view of a housing in a module of the device, occupied by a lobster,

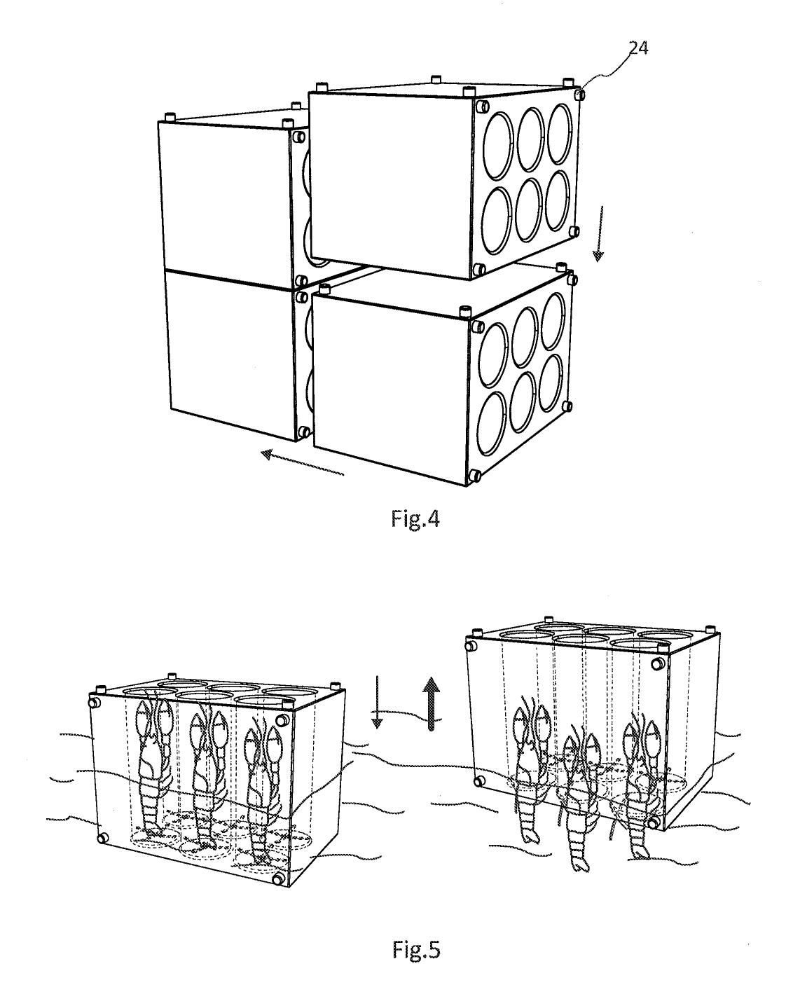

FIG. 4: a view of the means for nesting the modules of housings,

FIG. 5: a view of the extraction of the lobsters from a module,

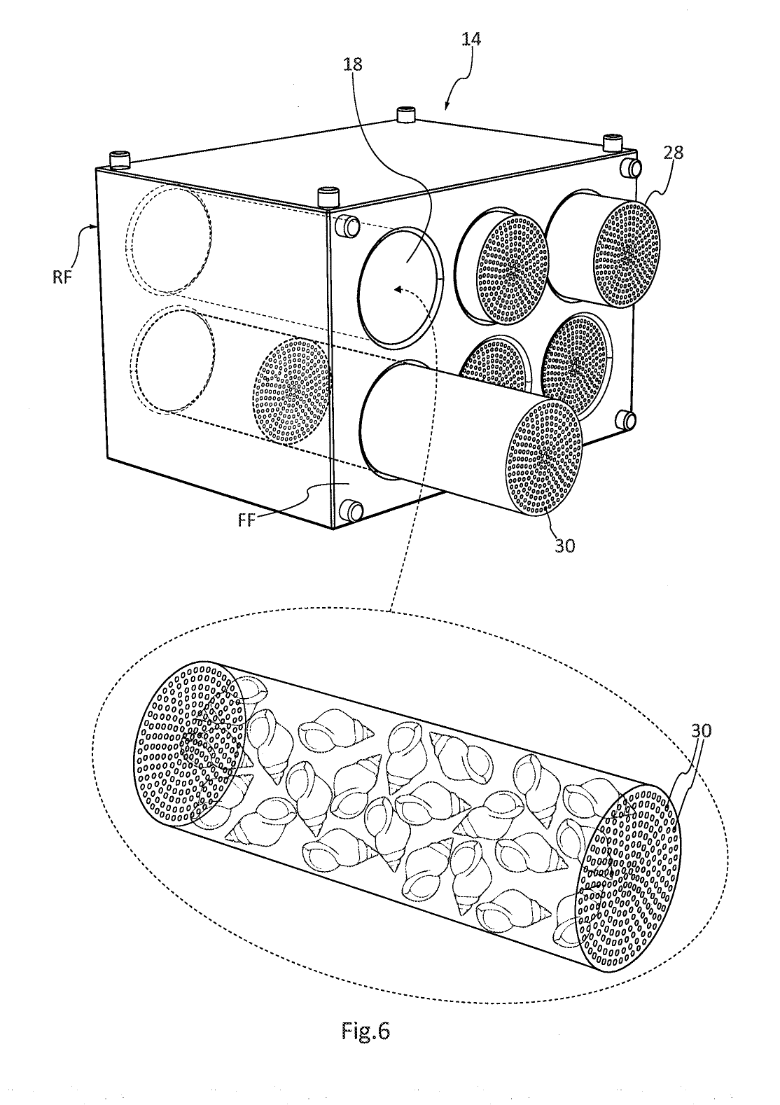

FIG. 6: a view of an arrangement for other sea products, notably mollusks.

The device 10 in accordance with the invention comprises a container 12 with at least one module 14 and a water treatment installation 16, see FIG. 1.

The container 12 represented is a container suited to the mode of transport and to the necessary standards, this being of no relevance to the present invention, these containers being known in themselves. This type of container is watertight and accessible via a watertight door.

This type of container is resistant to corrosion by sea water.

The module 14 in accordance with the present invention is a block of inert lightweight material resistant to corrosion by sea water of the expanded polymer type like the expanded polystyrene already used for packaging fish, crustaceans and the inert character of which requires no proof.

This lightweight material is in the form of a parallelepiped that is generally molded.

This parallelepiped has a length L and a width I defining a front face FF and a rear face RF as shown in FIG. 2.

The third dimension is the thickness E of this module.

This thickness E is equal to the overall length of the sea product to be introduced, in this instance a lobster, claws included.

In the embodiment, the width is intended to be oriented vertically, the length is oriented horizontally and the thickness E is also oriented horizontally. In all cases the orientation will be appropriate for the species.

The module includes housings 18 oriented parallel to the thickness E and opening onto both the front face FF and the rear face RF. The housings are therefore through-housings.

These housings 18 are preferably cylindrical and have a diameter D adapted to allow the introduction of a lobster, including the claws, as represented in FIG. 3.

Each housing 18 carries on its opening that opens onto the rear face RF partial blocking means 20. These partial blocking means 20 comprise at least one bar 22, for example a molded-in or attached bar, disposed along a diameter, or two bars forming a cross. These partial blocking means prevent the crustacean, notably the lobster, from moving and getting out via the opening of the housing 18 that opens onto said rear face.

These partial blocking means 20 allow the circulating water to pass through and do not in any case constitute a blockage intended to produce a blind housing 18.

Moreover, in accordance with an improvement of the present invention, these partial blocking means 20 are adapted to be cut, the utility of which will be explained later in the description.

Each module optionally includes means 24 for positioning it and nesting it with an adjacent module, for example in the form of pins 26 disposed in the corners of the various faces, as shown in FIG. 4.

These positioning means 24 make it possible to produce a wall of modules 14 when necessary, notably in a large container, as represented in FIG. 1.

The storage and transportation device in accordance with the invention therefore consists of at least one module in which sea products, in this instance lobsters, are disposed one per housing.

These lobsters preferably have the claws closed and secured by elastic bands, in known manner.

They are introduced via the front face so that the tail of each lobster abuts against the partial blocking means 20.

As lobsters walk backwards, they remain in their housing.

The housings being horizontal, it is easy to fill these housings one by one.

Once the first wall of modules has been completed, it is possible to erect a second wall and also to fill the housings with lobsters. The walls can therefore succeed one another through juxtaposition.

The rear partial blocking means of a module of a wall also constitute front partial blocking means of the housing of a juxtaposed module of a juxtaposed wall.

This yields a high density of sea products per unit container volume. No lobster is subjected to any pressure caused by accumulation as in a fish tank. There is no risk of mortality through compression or tangling.

Placement is extremely rapid.

Likewise the stacking of the modules and the juxtaposition of the walls, and so the lobsters remain out of water for a minimum time.

The container 12 is then hermetically sealed.

The treatment means 16 can then come into operation, first by introducing into the container water of appropriate composition in terms of salinity, oxygen and other mineral and/or nutrient substances. Thus there is an incoming flow.

It is known that the container may be filled with water in liquid bath form or in continuously sprayed form.

If the container is filled with water, it is clear that the volume of water is uniquely that of the housings less the volume of the lobsters and so the quantity of water is very limited.

The essential volume of the container is occupied by the lobsters and by the lightweight material constituting the modules.

To give an idea of magnitude, a weight ratio of 50% of sea products can be achieved.

The water is then evacuated and constitutes an outgoing flow after having passed through all of the modules.

This water of the outgoing flow being recycled, the lobsters are in appropriate living conditions. Moreover, in case of impacts, vibration, movement of the containers, they are largely damped by the water and by the lightweight material, which necessarily has a high absorption capacity.

It is also possible to dispose of labels associated with the modules or to provide a distribution of batches, if only by means of a color code.

At the destination, after draining, opening of the container, the walls can be demounted and the modules with their lobsters are distributed as a function of the destination, without taking said lobsters from their housings.

The latter undergo a minimum of manipulations until they reach the place of sale to the consumer.

If on the other hand batches of lobsters must again be placed in a fixed fish tank for long-term storage, then extracting the lobsters is very easy.

It suffices to place each module immediately above the surface of the water in the fish tank, with the rear face above the water, or even partially immersed.

By a slow downward and forward movement and a brisk upward movement the partial blocking means 20 are broken and the lobsters descend into the water of the fish tank, tail first, as represented in FIG. 5.

This therefore very greatly limits the trauma suffered by crustaceans treated in this way.

Note also that the modules can be placed directly in fish tanks or in containers with means for spraying water of appropriate composition and treated continuously.

Lobsters have been taken by way of example but it may be imagined that crabs, oysters, sea urchins directly placed in bulk although this may be difficult for products such as small mollusks, some echinoderms or small fish.

In FIG. 6 there has been represented a variant embodiment that finds an application to sea products of this type.

There is then provided an additional container 28 that receives a certain number of sea products of small size as a function of the product type. This container 28 is itself intended to be disposed in a housing 18 and therefore has smaller dimensions than a housing 18, with a clearance allowing free nesting or nesting with slight friction.

This container necessarily comprises openings 30 on its two faces so as to allow the incoming water flow and the outgoing water flow to pass through. It is also possible to provide openings on the lateral faces if necessary.

It must be possible for this container 28 to have the water flow pass through it.

On the other hand the openings 30 are sized so that the sea products remain in said container without being able to escape from it.

The various problematics explained in the preamble are therefore solved by the main

1-11. (canceled)

12. A module for storing and transporting live sea products, wherein it comprises a block of lightweight material in the form of a parallelepiped with a length L and a width 1 defining a front face FF and a rear face RF as well as a thickness E, including several housings having a dimension equal to the overall length of the sea product or of the container of sea products to be introduced, these housings being oriented parallel to the thickness E and opening onto both the front face FF and the rear face RF.

13. The module as claimed in claim 12 for storing and transporting living sea products, wherein the block of lightweight material in the form of a parallelepiped is molded.

14. The module as claimed in claim 12 for storing and transporting living sea products, wherein it comprises means for partially blocking one of the openings of said housings.

15. The module as claimed in claim 14 for storing and transporting living sea products, wherein the partial blocking means are disposed on the rear face RF.

16. The module as claimed in claim 14 for storing and transporting living sea products, wherein the partial blocking means comprise at least one bar.

17. The module as claimed in claim 16 for storing and transporting living sea products, wherein the partial blocking means comprise at least one bar molded with the block.

18. The module as claimed in claim 12 for storing and transporting living sea products, wherein the block of inert lightweight material is of expanded polymer.

19. The module as claimed in claim 18 for storing and transporting living sea products, wherein the polymer is polystyrene.

20. The module as claimed in claim 12 for storing and transporting living sea products, wherein it comprises containers receiving living sea products having dimensions less than those of a housing and including openings.

21. The module as claimed in claim 12 for storing and transporting living sea products, wherein the housing is of cylindrical shape and has a diameter D greater than the diameter of the living sea product or of the container to be introduced into said housing.

22. The module as claimed in any claim 12 for storing and transporting living sea products, wherein it includes positioning means for nesting with an adjacent module, in the form of pins.

23. A device for storing and transporting living sea products including at least one module as claimed in claim 12, wherein it comprises a closed container receiving said at least one module and salt water of appropriate composition for the living sea products and an installation for treating water of appropriate composition.

24. The device according to claim 23, wherein it comprises at least one wall of stacked modules.

25. The device according to claim 24, wherein it comprises at least two juxtaposed walls of stacked modules.

26. The device according to claim 25, wherein the modules comprise means for partially blocking one of the openings of the housings and the rear partial blocking means of a module of a wall also constitute front partial blocking means of the housing of a juxtaposed module of a juxtaposed wall.

27. The device as claimed in claim 23 for storing and transporting living sea products, wherein the water is introduced into the container in the form of a circulating bath of liquid or in continuously sprayed form.

28. The device as claimed in claim 23, wherein the water treatment installation adjusts at least the oxygenation and the salinity.

29. The device as claimed in claim 23, wherein the modules are filled with sea products and the weight ratio of sea products in the container is at least 50%.
